(19) United States
(12) Patent Application Publication
(10) Pub. No.: US 2010/0324965 A1
(43) Pub. Date: Dec. 23, 2010

(54) APPARATUS, METHOD AND ARTICLE TO EVALUATE AFFILIATE PERFORMANCE

(76) Inventors: Michael Joe Croix, Seattle, WA (US); Elliot Andrew Paquette, Seattle, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/819,086

(22) Filed: Jun. 18, 2010

Related U.S. Application Data
(60) Provisional application No. 61/268,949, filed on Jun. 18, 2009.
(60) Provisional application No. 61/265,623, filed on Dec. 1, 2009.

(51) Int. Cl. G06Q 10/00; G06Q 30/00

(52) U.S. Cl. 705/9; 705/14.46; 705/11; 705/14.45

(57) ABSTRACT

An affiliate evaluation system rates the quality of affiliates' marketing efforts in electronic commerce. Such may employ information from a customer relationship management (CRM) program, tool or system, along with more traditional lead evaluation criteria, including lead evaluation by third party tools or systems. Individual leads may be assigned lead quality scores based on various criteria such as CRM criteria, and individual affiliates may be assigned affiliate quality scores based on the lead quality scores of leads generated by the affiliate. Affiliate compensation and status may be determined from these affiliate quality scores and transmitted to an affiliate network, advertiser's affiliate program software and/or individual affiliate.

### CROSS REFERENCE TO RELATED APPLICATIONS

This application claims benefit under 35 U.S.C. 119(e) to U.S. provisional patent application Ser. No. 61/268,949 filed Jun. 18, 2009; and U.S. provisional patent application Ser. No. 61/265,623 filed Dec. 1, 2009, both of which are incorporated herein by reference in their entireties.

### BACKGROUND

1. Technical Field

The present disclosure generally relates to networked systems, and in particular networked systems that evaluate affiliate performance.

2. Description of the Related Art

Electronic commerce is becoming increasing ubiquitous. The volume of sales completed using electronic systems is increasing, as is the volume of electronic advertising and marketing. Electronic commerce provides convenience for consumers, as well as the ability to comparison shop. Electronic commerce also provides retailers the ability to present goods and services to consumers who would have been previously out of reach of a traditional “bricks and mortar” retailer. The digital advertising market that largely drives electronic commerce is a relatively new and rapidly changing marketplace. In order to compete successfully in the digital marketing space it is crucial to have a clear understanding of the various sub-specialties within digital marketing (e.g., Pay Per Click, Email Marketing, Search, Display, etc) as well as how best to employ these marketing approaches to maximize ROI.

Because of the highly competitive and technical nature of these sub-specialties, many businesses cannot afford to maintain an in-house marketing department and choose instead to outsource their digital marketing to affiliates though an affiliate marketing program. These affiliate marketing programs are business arrangements that allow affiliates to market a company's products and services in exchange for a fee. Affiliate marketing programs generally employ a computer software program or application that provide affiliates with digitally unique marketing materials (banners, text links, email creatives, etc) allowing the company to track the affiliate's various marketing efforts.

In order to extend their marketing reach even further, many companies turn towards affiliate network organizations, commonly referred to in the trade as affiliate networks. Affiliate networks are digital meeting grounds for advertisers (who have a product or service to sell) and affiliates (who market the advertiser's product or service for a fee). Unlike the affiliates in a company's affiliate marketing program described above, all the affiliates participating in an affiliate network are managed by the affiliate network entity itself. Affiliate networks also provide a technical framework for ad serving, tracking and payment, along with technical support, account management and dispute resolution services, typically via one or more computer software programs or applications.

There are a large variety of compensation schemes possible for affiliates within an affiliate program—whether managed by the company itself, or by an affiliate network. One of the simplest is cost per thousand (CPM) in which the affiliate or publisher is paid for each instance a particular advertisement is displayed (as with a banner ad or website) or sent (as with email marketing). One disadvantage of CPM payment schemes for advertisers is that they pay affiliates regardless of whether or not a potential customer actually reads the particular advertisement. Cost per click (CPC) theoretically lessens the advertiser's risk by charging them only when a potential customer makes an active selection (e.g., clicks) on the advertisement. Another approach is cost per lead (CPL) in which advertisers are only charged for actual leads produced that meet specified criteria (i.e., qualified leads). A further approach is cost per sale (CPS), also known as cost per sale, in which advertisers only pay for a completed sale. Incidentally, cost per action (CPA) is a general term used to refer to both CPL and CPS payout structures.

Many of the above payment schemes are prone to manipulation and fraud by an affiliate. For example, an affiliate may use their advertising links to fill out a contact form with bogus data in order to get paid on a CPL basis, or employ a computer program to click on their advertisements in order to get paid on a CPC basis. Many of the above payment schemes additionally, or alternatively, may not accurately reflect the actual value of a lead (e.g., one lead may result in sale while another does not). New approaches to automatically evaluate the relative value of the advertising traffic an affiliate provides, regardless of the payment scheme, is desirable in the affiliate marketing space.

### BRIEF SUMMARY

A method of operating a computer system may be summarized as including: for each of a plurality of leads generated by a number of affiliates, automatically tracking a number of defined activities related to sales via a customer relationship management program executed by at least one processor of the computer system; for each of at least some of the leads, determining by at least one processor of the computer system a lead quality score based at least in part on an outcome of each of a number of sales activities; and for each of at least some of the number of affiliates that originated the leads, determining by at least one processor of the computer system a respective affiliate quality score for the affiliate based at least in part on the determined lead quality scores of the leads generated by the respective affiliate, the affiliate quality score indicative of an assessment of quality of the leads generated by the respective affiliate.

The method may further include: for each of at least some of the plurality of leads, determining an initial lead quality score by at least one processor of the computer system; entering the leads into a database of the customer relationship management program executed by the at least one processor of the computer system; and assigning at least some of the leads to a number of sales people based at least in part on the initial lead quality scores before automatically tracking a number of defined activities related to sales via a customer relationship management program executed by at least one processor of the computer system. The method may further include: updating the initial lead quality score based on an occurrence of a return on investment event. The method may further include: receiving a set of initial lead quality parameters from a third party lead scoring tracker, wherein determining an initial lead quality score includes determining the initial lead quality score based at least in part on the set of initial lead quality parameters. The method may further include: updating the lead quality score by at least one processor of the computer system based on an occurrence of a return on investment event; and receiving an indication of the occurrence of the return of investment event from the customer relationship management program. The method may further include: for each of at least some of the affiliates, determining a payment category for the affiliate by at least one processor of the computer system based at least in part on the respective affiliate quality score determined for the affiliate. Determining a payment category for the affiliate by at least one processor of the computer system based at least in part on the respective affiliate quality score determined for the affiliate may include: determining whether a confidence level for the respective affiliate quality score; and assigning the affiliate to a payment category indicative of no payment if the determined confidence level for the respective affiliate quality score is below a confidence level threshold. The method may further include: transmitting information by at least one processor of the computer system to a system of at least one of an affiliate network or an individual affiliate, the information indicative of a new payout parameter (e.g., amount) for at least one of the affiliates, an effective date of the new payout parameter, and the determined affiliate quality score for the at least one of the affiliates. Determining a subsequent lead quality score based at least in part on an outcome of each of a number of sales activities may include determining a subsequent lead quality score based at least in part on an outcome of each of a number of sales activities performed by at least one sales person. Determining by at least one processor of the computer system a respective affiliate quality score for the affiliate may include determining the respective affiliate quality score for the affiliate based at least in part on a combination of the determined lead quality scores based on the outcome of the sales activities for the respective lead, a set of initial lead quality parameters for the respective lead received from a third party lead scoring tracker and/or evaluation data, and an occurrence of any return on investment events for the respective lead. The method may further include: determining a confidence level for the respective affiliate quality score, wherein the respective affiliate quality score is not used before the determined confidence level is above a threshold confidence level. Determining a confidence level for the respective affiliate quality score may include determining confidence level based at least in part on a variance between at least some of the lead quality scores. Determining by at least one processor of the computer system a respective affiliate quality score for the affiliate may include determining at least one of an average or a mean of all available lead quality scores for the leads generated by the respective affiliate without regard to a total number of leads generated by the respective affiliate. Determining by at least one processor of the computer system a respective affiliate quality score for the affiliate may include determining at least one of an average or a mean of all available lead quality scores for leads generated by the respective affiliate if a total number of available lead quality scores for leads generated by the respective affiliate is at least equal to a threshold total number of available lead quality scores for leads generated by the respective affiliate. The threshold total number of available lead quality scores for leads generated by the respective affiliate may be a fixed value (i.e., one that does not change to account for variability, e.g., 30). The threshold total number of available lead quality scores for leads generated by the respective affiliate may be determined based at least in part on a variability in the lead quality scores of leads generated by the respective affiliate. The threshold total number of available lead quality scores for leads generated by the respective affiliate may be determined based at least in part on a variability between the affiliate quality score of the respective affiliate and an affiliate quality score of at least one other affiliate. Determining by at least one processor of the computer system a respective affiliate quality score for the affiliate may include determining at least one of an average or a mean of all available lead quality scores for leads generated by the respective affiliate and at least one of an average or a mean of a number of available lead quality scores for leads generated by at least one other affiliate if a total number of available lead quality scores for leads generated by the respective affiliate is not at least equal to a threshold total number of available lead quality scores for leads generated by the respective affiliate.

A system may be summarized as including: at least one processor; at least one computer-readable storage medium that stores instructions executable by the at least one processor and which cause the at least one processor to automatically evaluate affiliates, by: for each of a plurality of leads generated by a number of affiliates, automatically tracking a number of defined activities related to sales via a customer relationship management program executed by at least one processor of the computer system; for each of at least some of the leads, determining by at least one processor of the computer system a lead quality score based at least in part on an outcome of each of a number of sales activities recorded via the customer relationship management tool; and for each of at least some of the number of affiliates that originated the leads, determining by at least one processor of the computer system a respective affiliate quality score for the affiliate based at least in part on the determined lead quality scores of the leads generated by the respective affiliate, the affiliate quality score indicative of an assessment of quality of the leads generated by the respective affiliate. The instructions may cause the at least one processor to evaluate affiliates further by: for each of at least some of the plurality of leads, determining an initial lead quality score by at least one processor of the computer system; entering the leads into a database of the customer relationship management program executed by the at least one processor of the computer system; and assigning at least some of the leads to a number of sales people based at least in part on the initial lead quality scores before automatically tracking a number of defined activities related to sales via a customer relationship management program executed by at least one processor of the computer system. The instructions may cause the at least one processor to evaluate affiliates further by: updating the initial lead quality score based on an occurrence of a return on investment event. The instructions may cause the at least one processor to evaluate affiliates further by: receiving a set of initial lead quality parameters from a third party lead scoring tracker, wherein determining an initial lead quality score includes determining the initial lead quality score based at least in part on the set of initial lead quality parameters and/or a set of evaluation data. The instructions may cause the at least one processor to evaluate affiliates further by: updating the lead quality score by at least one processor of the computer system based on an occurrence of a return on investment event; and receiving an indication of the occurrence of the return of investment event from the customer relationship management program. The instructions may cause the at least one processor to evaluate affiliates further by: for each of at least some of the affiliates, determining a payment category for the affiliate by at least one processor of the computer system based at least in part on the respective affiliate quality score determined for the affiliate. The instructions may cause the at least one processor to evaluate affiliates further by: transmitting information by at least one processor of the computer system to an affiliate management software program of an affiliate network or an individual affiliate, the information indicative of a new payout parameter (e.g., amount) for at least one of the affiliates, an effective date of the new payout amount, and the determined affiliate quality score for the at least one of the affiliates. Determining a subsequent lead quality score based at least in part on an outcome of each of a number of sales activities may include determining a subsequent lead quality score based at least in part on an outcome of each of a number of sales activities performed by at least one sales person. Determining by at least one processor of the computer system a respective affiliate quality score for the affiliate may include determining the respective affiliate quality score for the affiliate based at least in part on a combination of the determined lead quality scores based on the outcome of the sales activities for the respective lead, a set of initial lead quality parameters for the respective lead received from a third party lead scoring tracker, an occurrence of any return on investment events for the respective lead and/or a set of evaluation data. The system may store instructions that cause at least one processor to determine a respective affiliate quality score for the affiliate by determining at least one of an average or a mean of all available lead quality scores for leads generated by the respective affiliate if a total number of available lead quality scores for leads generated by the respective affiliate is at least equal to a threshold total number of available lead quality scores for leads generated by the respective affiliate. The threshold total number of available lead quality scores for leads generated by the respective affiliate is fixed. Alternatively, the instructions may cause the at least one processor to determine the threshold total number of available lead quality scores for leads generated by the respective affiliate based at least in part on a variability in the lead quality scores of leads generated by the respective affiliate. Alternatively, the instructions may cause the at least one processor to determine the threshold total number of available lead quality scores for leads generated by the respective affiliate based at least in part on a variability between the affiliate quality score of the respective affiliate and an affiliate quality score of at least one other affiliate. The at least one processor may be configured to perform any of the acts of the methods described above, or herein. Further, a computer- or processor-readable storage medium may store instructions that when executed by one or more processors cause the processor to perform any of the acts of the methods described above or herein.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic view of an electronic commerce environment including a number of advertisers, a number of affiliate networks including a number of affiliates, a number of independent affiliates, a number of third party tracking systems, and an affiliate evaluation system, according to one illustrated embodiment.

FIG. 2 is a functional block diagram of an affiliate evaluation system, according to another illustrated embodiment.

FIG. 3 is a flow diagram of a method of operating an affiliate evaluation computer system in an electronic commerce environment, according to one illustrated embodiment.

FIG. 4 is a data flow diagram illustrating a flow of data between various components in an electronic commerce environment, according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computer systems, server computers, and/or communications networks have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

This disclosure describes various systems, methods and articles related to electronic commerce and in particular evaluation of affiliates in electronic commerce. While specific structures and acts associated with particular illustrated embodiments are disclosed, other structures and acts may be employed in other embodiments.

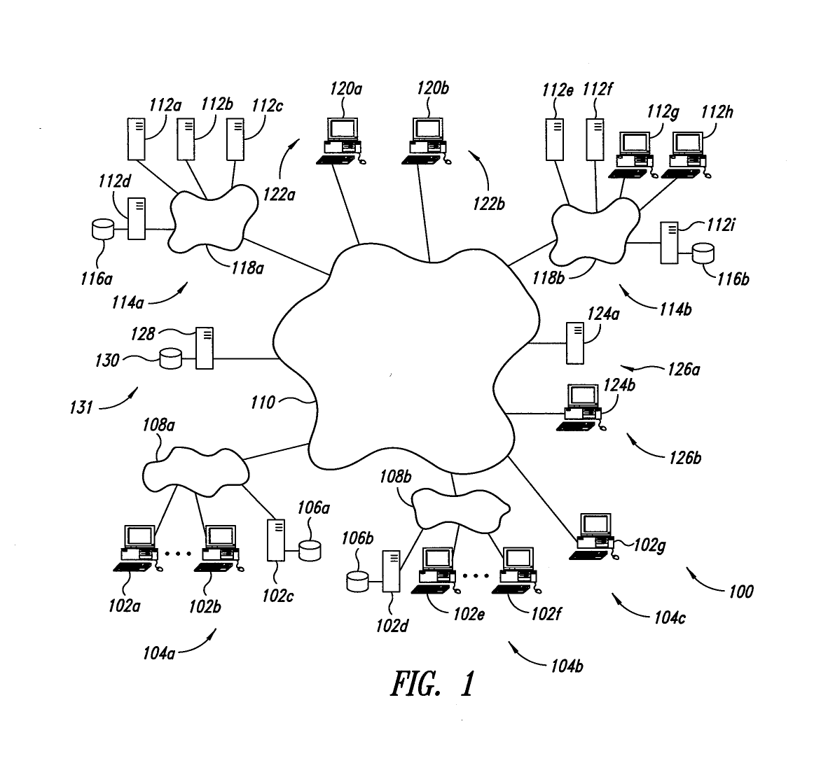

FIG. 1 shows an electronic commerce environment 100, according to one illustrated embodiment.

The electronic commerce environment 100 may include computer systems owned, operated by or for, or otherwise associated with various entities.

For example, the electronic commerce environment 100 may include a number of advertiser's computing systems 102a-102g (collectively 102) associated with one or more advertisers 104a-104c (collectively 104) such as retailers. The advertiser's computing systems 102 may include one or more servers 102c, 102d and associated databases stored on computer-readable media 106a, 106b (collectively 106). The advertiser's computing systems 102 may include one or more sales representative computer systems 102a, 102b, 102e-102g operated by, operated for, or otherwise associated with, one or more sales representatives. Sales representatives may contact potential customers or consumers or leads in a variety of fashions (e.g., email, phone, texting). The advertiser's computing systems 102 may be communicatively coupled to one another via one or more wired and/or wireless communications channels (not called out in FIG. 1) to form one or more advertiser networks 108a, 108b (collectively 108), for example one or more local area networks, wide area networks, or intranets. Alternatively, or additionally, the advertisers' computer systems 102 may be communicatively coupled to one another via a general access network 110, for instance the Internet. A customer relationship management program may execute on the server computer system 102 and/or on the sales representative computer systems 102.

For example, the electronic commerce environment 100 may include a number of affiliate network computing systems 112a-112i (collectively 112) associated with one or more affiliate network entities 114a, 114b. The affiliate network entity computer systems 112 may include a server computer system 112d, 112i, and associated databases stored on computer-readable media 116a, 116b (collectively 116). The affiliate network entity computer systems 112 may include one or more affiliate computer systems 112a-112c, 112e-112h. The affiliate network server 112d, 112i and affiliate computer systems 112a-112c, 112e-112h may be communicatively coupled to one another via one wired and/or wireless communications channels (not called out in FIG. 1) to form an affiliate network 118a, 118b (collectively 118), for example one or more local area networks, wide area networks, or intranets. Alternatively, or additionally, the affiliate network computer systems 112 may be communicatively coupled to one another via a general access network 110, for instance the Internet. One or more affiliate tracking and/or compensation program(s) may execute on the affiliate network server computer systems 112d, 112i. Such may track various characteristics of operating of the affiliates computer systems 112a-112c, 112e-112h such as instances of presentation of advertisements, selections or clicks on advertisements, completion of forms or surveys, and/or lead generated, and/or sales made. Such may additionally, or alternatively, determine compensation for each of the affiliates based on selected characteristics, for example portioning some portion of amounts received between various affiliates.

For example, the electronic commerce environment 100 may include a number of affiliate computer systems 120a, 120b (collectively 120) associated with one or more individual affiliates 122a, 122b (collectively 122) who are not associated with any particular affiliate network. Affiliates 112 may interact directly with advertisers 104, for example by serving advertisements and collecting fees in exchange for such.

For example, the electronic commerce environment 100 may include a number of third party tracking computing systems 124a, 124b (collectively 124) associated with one or more third party tracking entities 126, 126b (collectively 126). The third party tracking computing systems 124 may evaluate or rate leads generated by the affiliates using proprietary tools and algorithms. Such third party tracking computing systems 124 may communicatively provide information indicative of such evaluation or rating to various other computer systems.

For example, the electronic commerce environment 100 may include a number of affiliate evaluation computing systems 128 (only one illustrated) and associated databases stored on computer-readable media 130 accessible by the affiliate evaluation computing systems 128. The affiliate evaluation computing systems 128 may be operated by an affiliate evaluation entity 131. The affiliate evaluation entity 131 may be an independent entity, not controlled by, paid by or otherwise influenced by the affiliate networks, affiliates, advertisers and/or third party trackers. Alternatively, the affiliate evaluation entity 131 may be controlled by, or may actually be one of the affiliate networks, affiliates, advertisers and/or third party affiliate trackers. For example, the affiliate evaluation entity 131 may be the advertiser's or a group of advertisers. The affiliate evaluation computing systems 128 is configured to evaluate affiliates. In particular, the affiliate evaluation computing systems 128 is configured to automatically evaluate the quality of the leads, determine lead quality scores, determine affiliate quality, determine affiliate quality scores, and/or adjust affiliate compensation or affiliate network compensation based on lead quality measures. The affiliate evaluation computing systems 128 may be configured to automatically evaluate time spent on completion of forms or surveys or display of advertisements. The advertisers' computer systems 102 may execute a customer relationship management (CRM) program or instantiate a CRM function. Such may record, track and/or otherwise manage various sales related inputs (e.g., results of electronic mail, phone calls, sales status events). Output from the CRM program or function may be used as input to the affiliate evaluation computing systems 128. The synergistic interoperation between the CRM functions of the advertisers' computer systems 102 and the affiliate evaluation functionality of the affiliate evaluation computing systems 128 is considered particularly advantageous. Such operation is described in further detail herein.

While FIG. 1 illustrates a representative electronic commerce environment 100, typical electronic commerce environments may include many additional computer systems and entities. The concepts taught herein may be employed in a similar fashion to more populated electronic commerce environments.

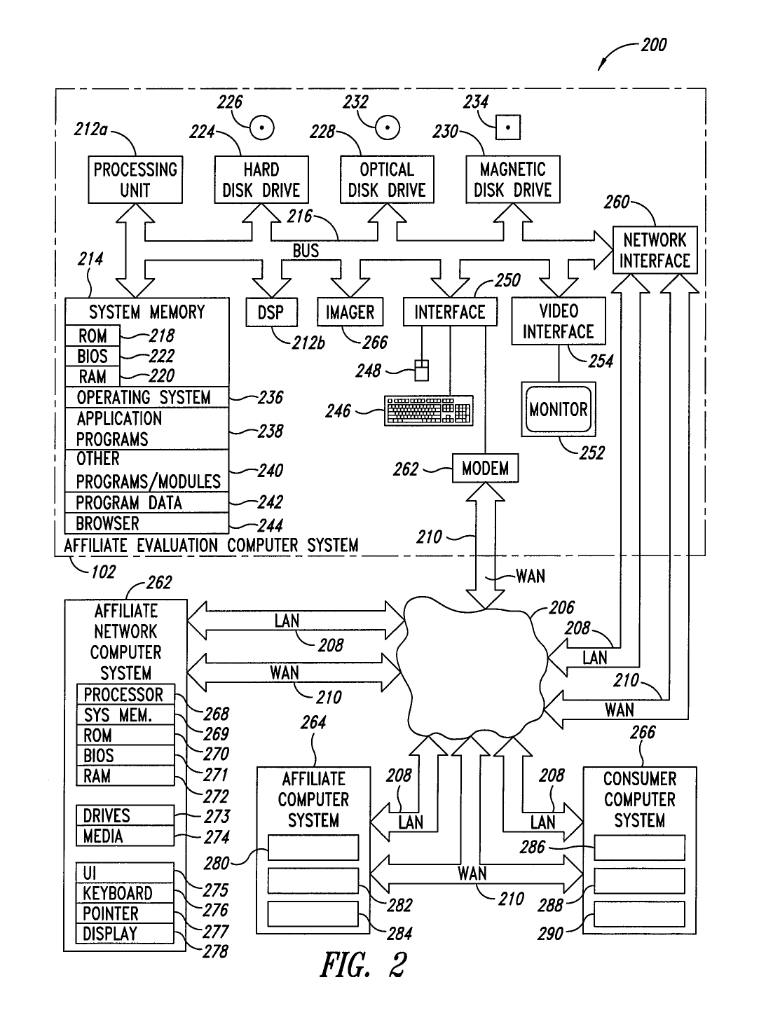

FIG. 2 and the following discussion provide a brief, general description of a suitable electronic commerce environment 200 in which the various illustrated embodiments can be implemented. Although not required, the embodiments will be described in the general context of computer-executable instructions, such as program application modules, objects, or macros stored on computer- or processor-readable media and executed by a computer or processor. Those skilled in the relevant art will appreciate that the illustrated embodiments as well as other embodiments can be practiced with other affiliate evaluation system configurations and/or other computing system configurations, including hand-held devices, multiprocessor systems, microprocessor-based or programmable consumer electronics, personal computers (“PCs”), network PCs, mini computers, mainframe computers, and the like. The embodiments can be practiced in distributed computing environments where tasks or modules are performed by remote processing devices, which are linked through a communications network. In a distributed computing environment, program modules may be located in both local and remote memory storage devices.

FIG. 2 shows an electronic commerce environment 200 comprising one or more affiliate evaluation computer systems 102, affiliate network server computer systems 262, and affiliate computer systems 264 communicatively coupled by one or more communications channels, for example one or more local area networks (LANs) 208 or wide area networks (WANs) 210. The electronic commerce environment 200 may employ other computer systems, for example potential customer or consumer computer systems and/or third party tracking computer systems, as previously described in reference to FIG. 1. The affiliate evaluation computer system 102 will at times be referred to in the singular herein, but this is not intended to limit the embodiments to a single device since in typical embodiments, there may be more than one affiliate evaluation computer system or devices involved. Unless described otherwise, the construction and operation of the various blocks shown in FIG. 2 are of conventional design. As a result, such blocks need not be described in further detail herein, as they will be understood by those skilled in the relevant art.

The affiliate evaluation computer system 102 may include one or more processing units 212a, 212b (collectively 212), a system memory 214 and a system bus 216 that couples various system components including the system memory 214 to the processing units 212. The processing units 212 may be any logic processing unit, such as one or more central processing units (CPUs) 212a, digital signal processors (DSPs) 212b, application-specific integrated circuits (ASICs), field programmable gate arrays (FPGAs), etc. The system bus 216 can employ any known bus structures or architectures, including a memory bus with memory controller, a peripheral bus, and a local bus. The system memory 214 includes read-only memory (“ROM”) 218 and random access memory (“RAM”) 220. A basic input/output system (“BIOS”) 222, which can form part of the ROM 218, contains basic routines that help transfer information between elements within the affiliate evaluation computer system 102, such as during start-up.

The affiliate evaluation computer system 102 may include a hard disk drive 224 for reading from and writing to a hard disk 226, an optical disk drive 228 for reading from and writing to removable optical disks 232, and/or a magnetic disk drive 230 for reading from and writing to magnetic disks 234. The optical disk 232 can be a CD-ROM, while the magnetic disk 234 can be a magnetic floppy disk or diskette. The hard disk drive 224, optical disk drive 228 and magnetic disk drive 230 may communicate with the processing unit 212 via the system bus 216. The hard disk drive 224, optical disk drive 228 and magnetic disk drive 230 may include interfaces or controllers (not shown) coupled between such drives and the system bus 216, as is known by those skilled in the relevant art. The drives 224, 228 and 230, and their associated computer-readable media 226, 232, 234, provide nonvolatile storage of computer readable instructions, data structures, program modules and other data for the affiliate evaluation computer system 102. Although the depicted affiliate evaluation computer system 102 is illustrated employing a hard disk 224, optical disk 228 and magnetic disk 230, those skilled in the relevant art will appreciate that other types of computer-readable media that can store data accessible by a computer may be employed, such as magnetic cassettes, flash memory cards, digital video disks (“DVD”), Bernoulli cartridges, RAMs, ROMs, smart cards, etc.

Program modules can be stored in the system memory 214, such as an operating system 236, one or more application programs 238, other programs or modules 240 and program data 242. Application programs 238 may include instructions that cause the processor(s) 212 to automatically evaluate the quality of the leads, determine lead quality scores, determine affiliate quality, determine affiliate quality scores, and/or adjust affiliate compensation or affiliate network compensation based on lead quality measures, as described in detail herein. Other program modules 240 may include instructions for handling security such as password or other access protection and communications encryption. The system memory 214 may also include communications programs for example a Web client or browser 244 for permitting the affiliate evaluation computer system 102 to access and exchange data with sources such as Web sites of the Internet, corporate intranets, extranets, or other networks as described below, as well as other server applications on server computing systems such as those discussed further below. The browser 244 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of Web clients or browsers are commercially available such as those from Mozilla, Google and Microsoft of Redmond, Wash.

While shown in FIG. 2 as being stored in the system memory 214, the operating system 236, application programs 238, other programs/modules 240, program data 242 and browser 244 can be stored on the hard disk 226 of the hard disk drive 224, the optical disk 232 of the optical disk drive 228 and/or the magnetic disk 234 of the magnetic disk drive 230.

An operator can enter commands and information into the affiliate evaluation computer system 102 through input devices such as a touch screen or keyboard 246 and/or a pointing device such as a mouse 248, and/or via a graphical user interface. Other input devices can include a microphone, joystick, game pad, tablet, scanner, etc. These and other input devices are connected to one or more of the processing units 212 through an interface 250 such as a serial port interface that couples to the system bus 216, although other interfaces such as a parallel port, a game port or a wireless interface or a universal serial bus (“USB”) can be used. A monitor 252 or other display device is coupled to the system bus 216 via a video interface 254, such as a video adapter. The affiliate evaluation computer system 102 can include other output devices, such as speakers, printers, etc.

The affiliate evaluation computer system 102 can operate in a networked environment using logical connections to one or more remote computers and/or devices. For example, the affiliate evaluation computer system 102 can operate in a networked environment using logical connections to one or more affiliate network server computer systems 262, affiliate computer systems 264 and/or third party tracking computer systems 266. Communications may be via a wired and/or wireless network architecture, for instance wired and wireless enterprise-wide computer networks, intranets, extranets, and the Internet. Other embodiments may include other types of communication networks including telecommunications networks, cellular networks, paging networks, and other mobile networks.

The affiliate network server computer system 262 may take the form of a conventional mainframe computer, mini-computer, workstation computer, personal computer (desktop or laptop), or handheld computer. The affiliate network server computer system 262 may include a processing unit 268, a system memory 269 and a system bus (not shown) that couples various system components including the system memory 269 to the processing unit 268. The affiliate network server computer system 262 will at times be referred to in the singular herein, but this is not intended to limit the embodiments to a single affiliate network server computer system 262 since in typical embodiments, there may be more than one affiliate network server computer system 262 or other device involved. Non-limiting examples of commercially available computer systems include, but are not limited to, an 80×86 or Pentium series microprocessor from Intel Corporation, U.S.A., a PowerPC microprocessor from IBM, a Sparc microprocessor from Sun Microsystems, Inc., a PA-RISC series microprocessor from Hewlett-Packard Company, or a 68xxx series microprocessor from Motorola Corporation.

The processing unit 268 may be any logic processing unit, such as one or more central processing units (CPUs), digital signal processors (DSPs), application-specific integrated circuits (ASICs), field programmable gate arrays (FPGAs), etc. Unless described otherwise, the construction and operation of the various blocks of the affiliate network server computer system 262 shown in FIG. 2 are of conventional design. As a result, such blocks need not be described in further detail herein, as they will be understood by those skilled in the relevant art.

The system bus can employ any known bus structures or architectures, including a memory bus with memory controller, a peripheral bus, and a local bus. The system memory 269 includes read-only memory (“ROM”) 270 and random access memory (“RAM”) 272. A basic input/output system (“BIOS”) 271, which can form part of the ROM 270, contains basic routines that help transfer information between elements within the peripheral computing system 114, such as during start-up.

The affiliate network server computer system 262 may also include one or more media drives 273 (e.g., a hard disk drive, magnetic disk drive, and/or optical disk drive) for reading from and writing to computer-readable storage media 274 (e.g., hard disk, optical disks, and/or magnetic disks). The computer-readable storage media 274 may, for example, take the form of removable media. For example, hard disks may take the form of a Winchester drives, optical disks can take the form of CD-ROMs, while magnetic disks can take the form of magnetic floppy disks or diskettes. The media drive(s) 273 communicate with the processing unit 268 via one or more system buses. The media drives 273 may include interfaces or controllers (not shown) coupled between such drives and the system bus, as is known by those skilled in the relevant art. The media drives 273, and their associated computer-readable storage media 274, provide nonvolatile storage of computer readable instructions, data structures, program modules and other data for the affiliate network server computer system 262. Although described as employing computer-readable storage media 274 such as hard disks, optical disks and magnetic disks, those skilled in the relevant art will appreciate that affiliate network server computer system 262 may employ other types of computer-readable storage media that can store data accessible by a computer, such as magnetic cassettes, flash memory cards, digital video disks (“DVD”), Bernoulli cartridges, RAMs, ROMs, smart cards, etc. Data or information, for example, data from customer relationship management programs or tools, third party tracking programs or tools, or tracking of leads, etc., can be stored in the computer-readable storage media 274.

Program modules, such as an operating system, one or more application programs, other programs or modules and program data, can be stored in the system memory 269. Program modules may include instructions for handling security such as password or other access protection and communications encryption. The system memory 269 may also include communications programs for example a Web client or browser that permits the affiliate network server computer system 262 to access and exchange data with sources such as Web sites of the Internet, corporate intranets, extranets, or other networks as described below, as well as other server applications on server computing systems such as those discussed further below. The browser may, for example be markup language based, such as Hypertext Markup Language (HTML), Extensible Markup Language (XML) or Wireless Markup Language (WML), and may operate with markup languages that use syntactically delimited characters added to the data of a document to represent the structure of the document.

While described as being stored in the system memory 269, the operating system, application programs, other programs/modules, program data and/or browser can be stored on the computer-readable storage media 274 of the media drive(s) 273. An operator can enter commands and information into the affiliate network server computer system 262 via a user interface 275 through input devices such as a touch screen or keyboard 276 and/or a pointing device 277 such as a mouse. Other input devices can include a microphone, joystick, game pad, tablet, scanner, etc. These and other input devices are connected to the processing unit 269 through an interface such as a serial port interface that couples to the system bus, although other interfaces such as a parallel port, a game port or a wireless interface or a universal serial bus (“USB”) can be used. A display or monitor 278 may be coupled to the system bus via a video interface, such as a video adapter. The affiliate network server computer system 262 can include other output devices, such as speakers, printers, etc.

The affiliate network server computer system 262 includes instructions stored in computer-readable storage media that cause the processor(s) of the affiliate network server computer system 262 to implement affiliate program functions. For example, the instructions may cause the processor(s) to provide a listing of available advertising opportunities to existing or potential affiliate members of the affiliate program. Such may include an identification of the advertiser, a listing of offers available to affiliates, copy or creative content for offers, an identification of any restrictions on placement of the advertising or other guidelines or rules or criteria governing the advertising, and/or an indication of the payment scheme for the advertising. Also for example, the affiliate network server computer system 262 may track performance by the affiliates members of the affiliate program, for instance the total number of instances of placement or views, total number of selections or clicks, total number of forms or surveys completed, sales made, amount of time spent by a potential customer on reviewing the advertising, and/or compliance with restrictions, rules or guidelines. Also for example, the affiliate network server computer system 262 may partition or otherwise determine payments owed to various affiliates and may even credit accounts or automatically generate payments to the affiliates.

The affiliate computer system 264 may take a variety of forms, for example one or more personal computers, server computers, mainframe computers, mini-computers, microcomputers or workstations. The affiliate computer system 264 may have identical or similar components to the previously described computer systems, for example a processing subsystem 280 including one or more processor and computer-readable memories, a media subsystem including one or more drives and computer-readable media, and one or more user interface subsystems 282 including one or more keyboards, keypads, displays, pointing devices, graphical interfaces and/or printers.

The affiliate computer system 264 includes instructions stored in computer-readable storage media that cause the processor(s) of the affiliate computer system 264 to implement affiliate functions. For example, the instructions may cause the processor(s) to provide advertising via various advertising channels, track responses to advertising, and submit any required reporting to the affiliate network server computer system 262.

The potential customer or consumer computer system 266 may take a variety of forms, for example one or more personal computers, server computers, mainframe computers, mini-computers, microcomputers or workstations. The potential customer or consumer computer system 266 may have identical or similar components to the previously described computer systems, for example a processing subsystem 286 including one or more processor and computer-readable memories, a media subsystem 288 including one or more drives and computer-readable media, and one or more user interface subsystems 290 including one or more keyboards, keypads, displays, pointing devices, graphical interfaces and/or printers.

The potential customer or consumer computer system 266 may include instructions that allow a customer to receive advertising and/or place orders or purchase items electronically. For example, the potential customer or consumer computer system 266 may include a Web browser that allows the potential customer to visit various Websites or Web pages provided by an affiliate and thereby view various advertisements. For instance, a potential customer or consumer may view Web pages of a newspaper Website, a consumer review Website, receive email marketing or a company newsletter, or visit a special interest Website (e.g., sports, hobbies). Advertisements may be provided in banners, hyperlinks, emails, or in any other fashion.

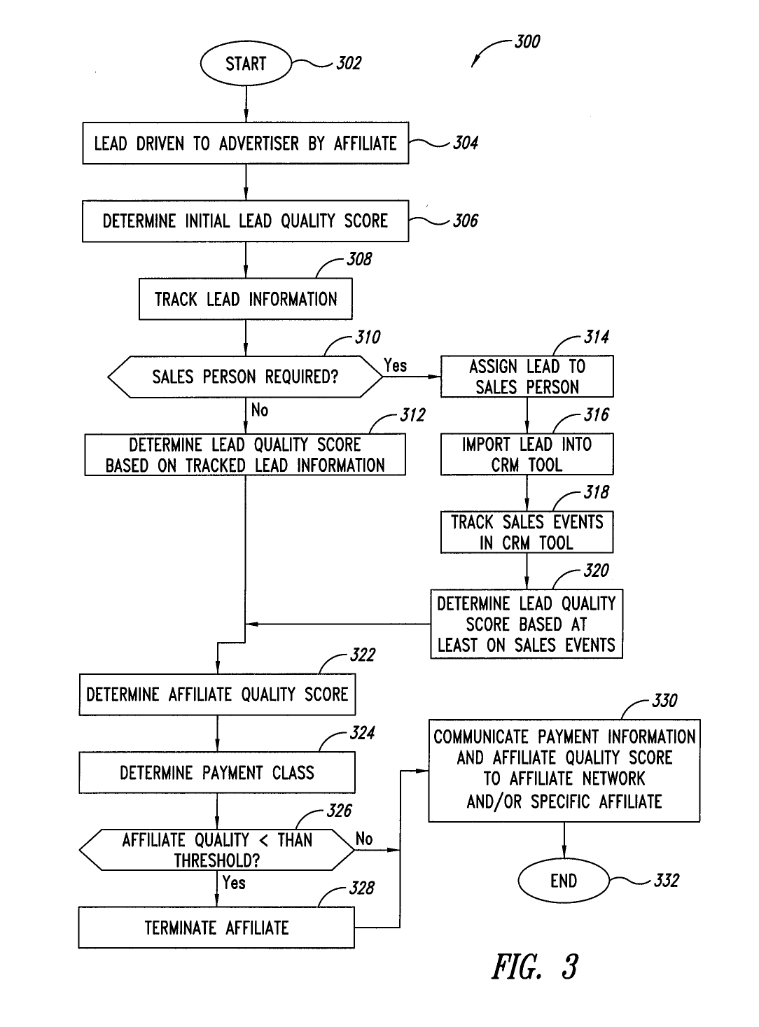

FIG. 3 shows a method 300 of operating an affiliate evaluation system in an electronic commerce environment, according to one illustrated embodiment.

The method 300 starts at 302. For example, the method 300 may start in response to an affiliate evaluation system being turned ON, receiving power, or in response to a call from a routine or program or other input.

At 304, a lead such as a potential customer or consumer operating a potential customer computer system or inquiry by the same is driven to an advertisement for an advertiser. The advertisement may be placed by an affiliate using an affiliate's system. The affiliate may, or may not, be a member or participant in an affiliate network hosted via an affiliate network computer system.

At 306, an initial lead quality score for the lead is determined. The initial lead quality score may, for example, be determined by a third party computer system. The evaluation data may, for example, be collected or determined by the affiliate evaluation system. In some embodiments, third party lead scoring tools may be employed. The initial lead quality score may be determined using third party tools and/or algorithms, which may, or may not be proprietary to the third party. Such third party tools often use predictive scoring methods based upon historical lead performance data and real-time and appended data to gauge the relative value of the lead for the advertiser providing the historical performance data. Others may attempt to detect fraud, such as automated selections or clicks of an advertiser's icon, which may be generated in a malicious attempt to increase advertisement revenue.

At 308, lead information may be tracked. Such may, for example be tracked using or by CRM software executing on a computing system, for instance executing on an advertiser's computer systems.

At 310, control branches depending on whether a sales person is required, or whether the lead may be followed or responded to automatically. For example, some leads require a sales person to answer specific questions, to ensure that the consumer is receiving the correct product, and/or to close the purchase. Other leads may simply require an automated email response or automated phone call to close the purchase.

If a sales person is not required, lead information is tracked automatically, for example by the affiliate evaluation system or by the affiliate computer system. Such lead information can take a variety of forms, and may, for instance, include whether repeat lead addresses (e.g., Internet Protocol or IP addresses) for the lead occur, which may indicate an automatic lead generation. Such lead information may additionally or alternatively include an indication of a time taken by a potential customer or consumer to complete a form. Lead information may additionally or alternatively include conversion ratios (i.e., percentage of visitors who convert casual views or visits to specific desired actions).

At 312, a lead quality score is determined based at least on the tracked lead information 308. The lead quality score may also be based on the determined initial lead score 306. The lead quality score may, for example, be determined by the affiliate evaluation system. The lead quality score may use any of a variety of algorithms which may consider a variety of factors, and/or weight factors in any variety of manner. For example, some lead information may reduce the value or quality of a lead, while other lead information may enhance the value of quality of the lead. For instance, if an email sent to an email address associated with a lead is bounced, such may reduce the value of quality of the lead. Alternatively, if the email is not bounced, or if the email is responded to, such may enhance the value of quality of the lead. Likewise, if a phone call to a telephone number associated with the lead indicated that the telephone number is not in service, has been disconnected, or is associated with an individual other than an individual identified by the lead, such may reduce the value of quality of the lead. Alternatively, if the individual identified by the lead answers the phone call, such may enhance the value of quality of the lead. Also for instance, if an individual identified by the lead expresses an interest, such may be given significant weight in any algorithm used to determine lead quality scores. Also for instance, if a sale actually occurs, other tracked lead information may be ignored or discounted, and the lead given a very high lead quality score.

If a sales person is required, the lead is assigned to a sales person at 314 and the lead is automatically imported into a CRM program, tool or system at 316. Various CRM programs which may be suitable are commercially available, and proprietary CRM programs exist or can be developed.

At 318, various sales events are tracked by the CRM program, tool or system. CRM programs and tools are specifically designed to track sale events, for instance emails, phone calls, mailings, other contacts with potential customers or consumers. Sales events may take a variety of forms. For example, sales events may include results from electronic mail (e.g., email) sent to an email address associated with the lead. Sales events may additionally, or alternatively, include results of phone calls made to the lead or a phone number associated with the lead. Sales events may additionally, or alternatively, include results of mailings made to the lead or a physical address associated with the lead. Sales events may additionally, or alternatively, include sales status.

At 320, a lead quality score for the lead is determined based at least on the tracked sales events. The lead quality score may also be determined based on the initial quality score. The lead quality score may additionally or alternatively be determined based on tracked lead information. The lead quality score may, for example, be automatically computationally determined by the affiliate evaluation system, using a variety of algorithms, factors or variables, and/or weightings.

Whether a sales person was required or not, at 322 an affiliate quality score is determined for a particular affiliate, based at least in part on the various determined lead quality scores for leads generated or originated by the particular affiliate. The affiliate quality score may, for example, be automatically computationally determined by the affiliate evaluation system, using a variety of algorithms, factors or variables, and/or weightings.

At 324, a payment class or category for the affiliate is determined based at least in part on the determined affiliate quality score. The payment class or category may, for example, be automatically computationally determined by the affiliate evaluation system, using a variety of algorithms, factors or variables, and/or weightings.

Optionally at 326, the determined affiliate quality score is compared to a defined affiliate quality threshold, and traffic by the particular affiliate may be terminated at 328 if the lead quality score is below some defined threshold. The comparison may be performed by the affiliate evaluation computer system. Thresholds may be predefined or may be dynamically defined.

At 330, payment information and the affiliate quality score are communicated to the affiliate network computing system to which an affiliate is a member or participant, to the advertiser's affiliate program software, and/or to an affiliate. In particular, the affiliate evaluation computer system may communicate the payment information and affiliate quality score to the affiliate network computer system or server. Additionally or alternatively, the affiliate evaluation computer system may communicate the payment information and affiliate quality score to an affiliate computer system that is associated with or a member of an affiliate network. Alternatively, the affiliate evaluation computer system may communicate the payment information and affiliate quality score to an affiliate computer system that is not associated with or is not a member of an affiliate network. Alternatively, the affiliate evaluation computer system may communicate the payment information and affiliate quality score to an advertiser's affiliate program software.

The method 300 may terminate at 332. Alternatively, the method 300 may continuously or periodically execute, for example as one or more threads in a multi-threaded operating system.

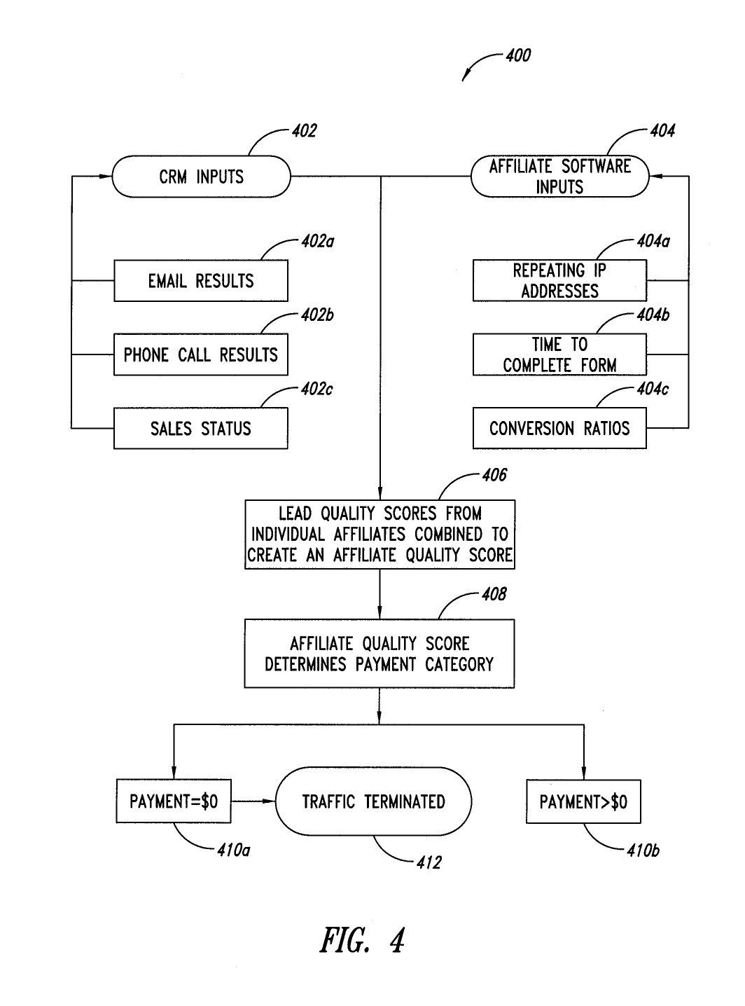

FIG. 4 shows a flow of data 400 between various components in an electronic commerce environment, according to one illustrated embodiment.

A CRM program, tool or system may collect and provide CRM data 402. The CRM data may be collected automatically by the computer system executing the CRM program, tool or system and/or may be manually input by a user of the CRM program, tool or system, for instance by a sales person. The CRM data 402 may take a variety of forms. For example, the CRM data 402 may include email results 402a, phone call results 402b, and/or sales status 402c indicative of a status of any potential sales to a lead.

An affiliate evaluation or ranking program, tool or system may collect and provide affiliate evaluation data 404. The affiliate evaluation data 404 may be collected automatically by the computer system executing the affiliate evaluation program, tool or system and/or may be manually input by a user of the CRM program, tool or system. The affiliate evaluation data 404 may take a variety of forms. For example, the affiliate evaluation data 404 may include indications of repeated IP address 404a, an indication of an amount of time spent by potential customers in completing forms 404b, and/or conversion ratio 404c.

Lead quality scores for leads generated or originated by individual affiliates may be combined or used to determine an affiliate quality score 406. Affiliate quality scores 406 may be used to determine payment class or categories (e.g., payment rates) 408 for the respective affiliates. Payment class or categories 408 may determine actual payment amounts 410a, 410b. For example, a payment rate may be applied to a total number of leads generated or originated by an affiliate. Such may, or may not, discount or subtract some number of leads that are determined to be fraudulent or otherwise invalid. Also for example, the payment class or category may specify a specific payment amount, without regard to the total number of leads generated or originated by the affiliate. For example, the affiliate may receive no payment where the affiliate quality score is below some defined threshold. Additionally, a termination determination and/or message 412 may be produced, for example where the affiliate quality score is below some defined threshold.

An affiliate evaluation or ranking program, tool or system may determine a confidence level for a respective affiliate quality score. The affiliate evaluation or ranking program, tool or system may assign the affiliate to a payment category indicative of no payment if the determined confidence level for the respective affiliate quality score is below a confidence level threshold. Alternatively, or additionally, the respective affiliate quality score may not be used to determine a payment category before the determined confidence level is above a threshold confidence level.

The affiliate evaluation or ranking program, tool or system may determine a confidence level for a respective affiliate quality score based at least in part on a variance between at least some of the lead quality scores.

The affiliate evaluation or ranking program, tool or system may determine a respective affiliate quality score for an affiliate by determining at least one of an average or a mean of all available lead quality scores for the leads generated by the respective affiliate without regard to a total number of leads generated by the respective affiliate. An affiliate evaluation or ranking program, tool or system may determine a respective affiliate quality score for an affiliate by determining at least one of an average or a mean of all available lead quality scores for leads generated by the respective affiliate if a total number of available lead quality scores for leads generated by the respective affiliate is at least equal to a threshold total number of available lead quality scores for leads generated by the respective affiliate. The affiliate evaluation or ranking program, tool or system may determine a respective affiliate quality score for an affiliate by determining at least one of an average or a mean of all available lead quality scores for leads generated by the respective affiliate and at least one of an average or a mean of a number of available lead quality scores for leads generated by at least one other affiliate if a total number of available lead quality scores for leads generated by the respective affiliate is not at least equal to a threshold total number of available lead quality scores for leads generated by the respective affiliate.

The system may advantageously take into account variation between lead scores from a given affiliate. Thus, affiliates with relatively low variation between lead scores may need a relatively low total number of leads to reach a desired confidence level. For example, where the averaged lead scores is equated to the quality score for the affiliate. Thus, such affiliates may receive credit on achievement of a relatively low total number of leads. In contrast, affiliates with relatively large variation between lead scores may need a relatively larger total number of leads to reach the desired confidence level. Thus, such affiliates may receive credit only on achievement of a relatively high total number of leads.

For instance, at least one processor of the computer system may determine a respective affiliate quality score for the affiliate by determining at least one of an average or a mean of all available lead quality scores for leads generated by the respective affiliate if a total number of available lead quality scores for leads generated by the respective affiliate is at least equal to a threshold total number of available lead quality scores for leads generated by the respective affiliate. The threshold total number of available lead quality scores for leads generated by the respective affiliate may be fixed (e.g., 30), for instance not being adjusted to account for variability. The threshold total number of available lead quality scores for leads generated by the respective affiliate may be variable, determined based on one or more of a variety of values or factors. For instance the threshold may be based at least in part on a variability in the lead quality scores of leads generated by the respective affiliate. Additionally or alternatively, the threshold may be based at least in part on a variability between the affiliate quality score of the respective affiliate and an affiliate quality score of at least one other affiliate.

In one example, a vendor or “advertiser”, in attempting to market a product, contracts affiliate networks (i.e., lead sources) to provide the vendor with possible marketing leads. The vendor's sales force actively work the leads, and enter various quality factors into a customer relationship management tool such as the lead being warm or cold, fraudulent or true, etc. From these quality factors, a lead is assigned a lead quality score, the computation of which is not discussed here.

The scores from individual leads coming from an affiliate are averaged to give a raw score. The scores being averaged may be only the scores for those ostensibly legitimate leads for which data exists. For instance, some “leads” are known to be tests and can be disregarded. Other leads, such as those containing profanities, are spurious, to no fault of the affiliate, and so are disregarded. Leads about which no data have been collected are also not useful to the ranking of an affiliate. All of these should be excluded. This score represents the best guess of the quality score of a lead generated by that particular affiliate. However, this guess lacks statistical significance if too few individual leads have been rated, and it subjects quality ratings to unnecessary variability.

Therefore, the vendor is forced to choose a confidence threshold. Above this threshold, the vendor can expect the raw score and affiliate quality score to be the same and reliable. Below this threshold, the vendor can hedge its bet. For example, if below the threshold, the vendor may replace the missing data points needed to reach the threshold with the global average score, the expected score of a lead coming from any source or from some subset of sources or affiliates. Above the threshold, the probability that the raw score deviates from the true affiliate quality will be small.

One way to think of this threshold is in terms of a fixed number (e.g., 30) of data points. After some large number of leads has been worked, the vendor may accept the raw score as trustworthy and therefore reliable as the affiliate quality score. Before this number of leads has been worked, the vendor may rate an affiliate using a weighted average of its raw score and the global average score. If this number is picked sufficiently large, the vendor can rest assured that its estimate (in the form of raw scores) accurately represents affiliate quality—this is the so-called weak law of large numbers.

This is a conceptually simple way to think of the confidence threshold, but it does not account for two problems, the non-linearity problem (i.e., diminishing returns) and the unresponsiveness problems (i.e., it is too conservative).

The non-linearity problem arises because the relationship between the number data points and probability of error is quite tortuous. Having 100 data points does not make the vendor twice as confident as having 50 data points. On the other hand, having 10 data points will (in all likelihood) make the vendor many times more confident than having 5 data points.

The unresponsiveness problem arises because some number of data points, say 30, can mean many different things. If all 30 data points lie on top of one another (i.e., closely grouped), the vendor will have no doubt in its estimate. On the other hand, if all 30 data points have huge spread (i.e., not closely grouped), the raw score will be cast in doubt. Thus the vendor is forced to be overly conservative, fixing a confidence threshold above what would be necessary if affiliates were investigated on a case-by-case basis.

The lesson from these two problems is that the number of data points is poor measure of confidence. There is a correction factor, due to D. Freedman, which can be stated in conceptual terms as the ratio of error tolerance to the amount of observed randomness. Thus confidence still increases with the number of data points, but is adjusted downwards in the event of high variance between data points. Likewise, confidence is adjusted upwards in the event of consistency between data points. The details are technical, but the formulae for computing the probability-of-error (formally, these are known as large deviation bounds) are quite simple and are provided immediately below.

In what follows let n be the number of data points (i.e., lead scores) x₁, x₂, x₃, . . . , xₙ. The algorithm will output q*, the hedged affiliate score. To do this, it will first compute p, the probability that the raw score deviates from the true affiliate score by more than error tolerance t. In order to compute this, the algorithm first computes the sample variance s². Further, the Freedman bound on p relies on a bound K greater than twice the absolute value of any lead quality score xᵢ; for the purposes here, K need not be so large. In practice, Kt is a parameter that affects the speed at which the vendor or algorithm adopts the raw score: the smaller the Kt, the more aggressively the vendor or algorithm adopts q. Roughly, Kt should be the size of the population variance (precompute the sample variance of some large random set of leads from disparate sources).

| Variable & Formula | Description |
|---|---|
| xᵢ | Lead score |
| n | Number of leads worked |
| $\text{?} = \frac{1}{n} \text{?} x \text{?}$ $\text{?} \text{indicates text missing or illegible when filed}$ | Raw source score |
| $\text{?} = \frac{1}{n - 1} \text{?} {( \text{?} - \text{?} )}^{2} \\ \text{?} \text{indicates text missing or illegible when filed}$ | Sample variance |
| [symbol] | Error tolerance |
| Kt | Conservativeness parameter: |
| | the smaller the Kt, the more |
| | aggressively the vendor adopts q |
| $\text{?} = min \{ \text{?} \}$ $\text{?} \text{indicates text missing or illegible when filed}$ | Probability the estimate q deviates from the true mean by more than error tolerance t |
| q [symbol] = pμ + (1 − p)q | Hedged source score |

[symbol]

indicates data missing or illegible when filed

Thus various approaches are described. The most rudimentary approach employs whatever number of leads scores are available in determining a raw affiliate score, without regard to a confidence level in the outcome. Other approaches may employ a minimum confidence level. For example, the affiliate score may not be used until the minimum confidence level has been achieved (e.g., some minimum number of leads evaluated). Alternatively, the affiliate may be assigned to a pay classification that receives not compensation until the confidence level meets or exceeds the confidence level threshold. Another approach may employ average affiliate score across one or more other affiliates to generate a sufficient number of samples to obtain the desired confidence level for a first affiliate. An even more refined approach adjusts the confidence level threshold based on spread between the lead scores of an affiliate, or even between affiliates. Thus, the confidence level threshold is adjusted upward as spread increases and adjusted downward as spread decreases. One or more of these approaches may be combined in whole or in part.

The described apparatus, methods and articles can evaluate affiliates based on a variety of criteria and based on information from a variety of sources. The described apparatus, methods and articles take advantage of the functionality supplied by CRM programs and other tools while effectively applying various compensation schemes to affiliates.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet, including but not limited to U.S. provisional patent application Ser. No. 61/268,949, filed Jun. 18, 2009, are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operating a computer system, comprising:
for each of a plurality of leads generated by a number of affiliates, automatically tracking a number of defined activities related to sales via a customer relationship management program executed by at least one processor of the computer system;
for each of at least some of the leads, determining by at least one processor of the computer system a lead quality score based at least in part on an outcome of each of a number of sales activities; and
for each of at least some of the number of affiliates that originated the leads, determining by at least one processor of the computer system a respective affiliate quality score for the affiliate based at least in part on the determined lead quality scores of the leads generated by the respective affiliate, the affiliate quality score indicative of an assessment of quality of the leads generated by the respective affiliate.

2. The method of claim 1, further comprising:
for each of at least some of the plurality of leads, determining an initial lead quality score by at least one processor of the computer system;
entering the leads into a database of the customer relationship management program executed by the at least one processor of the computer system; and
assigning at least some of the leads to a number of sales people based at least in part on the initial lead quality scores before automatically tracking a number of defined activities related to sales via a customer relationship management program executed by at least one processor of the computer system.

3. The method of claim 2, further comprising:
updating the initial lead quality score based on an occurrence of a return on investment event.

4. The method of claim 3, further comprising:
receiving a set of initial lead quality parameters from a third party lead scoring tracker, wherein determining an initial lead quality score includes determining the initial lead quality score based at least in part on the set of initial lead quality parameters.

5. The method of claim 1, further comprising:
updating the lead quality score by at least one processor of the computer system based on an occurrence of a return on investment event; and
receiving an indication of the occurrence of the return of investment event from the customer relationship management program.

6. The method of claim 1, further comprising:
for each of at least some of the affiliates, determining a payment category for the affiliate by at least one processor of the computer system based at least in part on the respective affiliate quality score determined for the affiliate.

7. The method of claim 6 wherein determining a payment category for the affiliate by at least one processor of the computer system based at least in part on the respective affiliate quality score determined for the affiliate includes:
determining whether a confidence level for the respective affiliate quality score has been reached; and
assigning the affiliate to a payment category indicative of no payment if the determined confidence level for the respective affiliate quality score is below a confidence level threshold.

8. The method of claim 6, further comprising:
transmitting information by at least one processor of the computer system to a system of at least one of an affiliate network, an advertiser or an individual affiliate, the information indicative of a new payout parameter for at least one of the affiliates, an effective date of the new payout parameter, and the determined affiliate quality score for the at least one of the affiliates.

9. The method of claim 1 wherein determining a subsequent lead quality score based at least in part on an outcome of each of a number of sales activities includes determining a subsequent lead quality score based at least in part on an outcome of each of a number of sales activities performed by at least one sales person.

10. The method of claim 1 wherein determining by at least one processor of the computer system a respective affiliate quality score for the affiliate includes determining the respective affiliate quality score for the affiliate based at least in part on a combination of the determined lead quality scores based on the outcome of the sales activities for the respective leads received from a third party lead scoring tracker, a set of initial lead quality parameters for the respective lead and/or an occurrence of any return on investment events for the respective lead.

11. The method of claim 1, further comprising:
determining a confidence level for the respective affiliate quality score, wherein the respective affiliate quality score is not used before the determined confidence level is above a threshold confidence level.

12. The method of claim 11 wherein determining a confidence level for the respective affiliate quality score includes determining confidence level based at least in part on a variance between at least some of the lead quality scores.

13. The method of claim 1 wherein determining by at least one processor of the computer system a respective affiliate quality score for the affiliate includes determining at least one of an average or a mean of all available lead quality scores for the leads generated by the respective affiliate without regard to a total number of leads generated by the respective affiliate.

14. The method of claim 1 wherein determining by at least one processor of the computer system a respective affiliate quality score for the affiliate includes determining at least one of an average or a mean of all available lead quality scores for leads generated by the respective affiliate if a total number of available lead quality scores for leads generated by the respective affiliate is at least equal to a threshold total number of available lead quality scores for leads generated by the respective affiliate.

15. The method of claim 14 wherein the threshold total number of available lead quality scores for leads generated by the respective affiliate is fixed.

16. The method of claim 14, further comprising:
determining the threshold total number of available lead quality scores for leads generated by the respective affiliate based at least in part on a variability in the lead quality scores of leads generated by the respective affiliate.

17. The method of claim 14, further comprising:
determining the threshold total number of available lead quality scores for leads generated by the respective affiliate based at least in part on a variability between the affiliate quality score of the respective affiliate and an affiliate quality score of at least one other affiliate.

18. The method of claim 1 wherein determining by at least one processor of the computer system a respective affiliate quality score for the affiliate includes determining at least one of an average or a mean of all available lead quality scores for leads generated by the respective affiliate and at least one of an average or a mean of a number of available lead quality scores for leads generated by at least one other affiliate if a total number of available lead quality scores for leads generated by the respective affiliate is not at least equal to a threshold total number of available lead quality scores for leads generated by the respective affiliate.

19. A system, comprising:
at least one processor;
at least one computer-readable storage medium that stores instructions executable by the at least one processor and which cause the at least one processor to automatically evaluate affiliates, by:
for each of a plurality of leads generated by a number of affiliates, automatically tracking a number of defined activities related to sales via a customer relationship management program executed by at least one processor of the computer system;
for each of at least some of the leads, determining by at least one processor of the computer system a lead quality score based at least in part on an outcome of each of a number of sales activities; and
for each of at least some of the number of affiliates that originated the leads, determining by at least one processor of the computer system a respective affiliate quality score for the affiliate based at least in part on the determined lead quality scores of the leads generated by the respective affiliate, the affiliate quality score indicative of an assessment of quality of the leads generated by the respective affiliate.

20. The system of claim 19 wherein the instructions cause the at least one processor to evaluate affiliates further by:
for each of at least some of the plurality of leads, determining an initial lead quality score by at least one processor of the computer system;
entering the leads into a database of the customer relationship management program executed by the at least one processor of the computer system; and
assigning at least some of the leads to a number of sales people based at least in part on the initial lead quality scores before automatically tracking a number of defined activities related to sales via a customer relationship management program executed by at least one processor of the computer system.

21. The system of claim 20 wherein the instructions cause the at least one processor to evaluate affiliates further by:
updating the initial lead quality score based on an occurrence of a return on investment event.

22. The system of claim 21 wherein the instructions cause the at least one processor to evaluate affiliates further by:
receiving a set of initial lead quality parameters and evaluation data from a third party lead scoring tracker, wherein determining an initial lead quality score includes determining the initial lead quality score based at least in part on the set of initial lead quality parameters.

23. The system of claim 19 wherein the instructions cause the at least one processor to evaluate affiliates further by:
updating the lead quality score by at least one processor of the computer system based on an occurrence of a return on investment event; and
receiving an indication of the occurrence of the return of investment event from the customer relationship management program.

24. The system of claim 19 wherein the instructions cause the at least one processor to evaluate affiliates further by:
for each of at least some of the affiliates, determining a payment category for the affiliate by at least one processor of the computer system based at least in part on the respective affiliate quality score determined for the affiliate.

25. The system of claim 19 wherein the instructions cause the at least one processor to evaluate affiliates further by:
transmitting information by at least one processor of the computer system to at least one computer of at least one of an affiliate network, an advertiser or an individual affiliate, the information indicative of a new payout parameter for at least one of the affiliates, an effective date of the new payout parameter, and the determined affiliate quality score for the at least one of the affiliates.

26. The system of claim 19 wherein determining a subsequent lead quality score based at least in part on an outcome of each of a number of sales activities includes determining a subsequent lead quality score based at least in part on an outcome of each of a number of sales activities performed by at least one sales person.

27. The system of claim 19 wherein determining by at least one processor of the computer system a respective affiliate quality score for the affiliate includes determining the respective affiliate quality score for the affiliate based at least in part on a combination of the determined lead quality scores based on the outcome of the sales activities for the respective lead received from a third party lead scoring tracker, a set of initial lead quality parameters and evaluation data for the respective lead, and/or an occurrence of any return on investment events for the respective lead.

28. The system of claim 19 wherein the instructions cause the at least one processor to determine a respective affiliate quality score for the affiliate by determining at least one of an average or a mean of all available lead quality scores for leads generated by the respective affiliate if a total number of available lead quality scores for leads generated by the respective affiliate is at least equal to a threshold total number of available lead quality scores for leads generated by the respective affiliate.

29. The system of claim 28 wherein the threshold total number of available lead quality scores for leads generated by the respective affiliate is fixed.

30. The system of claim 28 wherein the instructions cause the at least one processor to:
determine the threshold total number of available lead quality scores for leads generated by the respective affiliate based at least in part on a variability in the lead quality scores of leads generated by the respective affiliate.

31. The system of claim 28 wherein the instructions cause the at least one processor to:
determine the threshold total number of available lead quality scores for leads generated by the respective affiliate based at least in part on a variability between the affiliate quality score of the respective affiliate and an affiliate quality score of at least one other affiliate.

32. A computer-readable storage medium that stores instructions which when executed by a processor cause the processor to evaluate affiliates, by:
for each of a plurality of leads generated by a number of affiliates, automatically tracking a number of defined activities related to sales via a customer relationship management program executed by at least one processor of the computer system;
for each of at least some of the leads, determining by at least one processor of the computer system a lead quality score based at least in part on an outcome of each of a number of sales activities; and
for each of at least some of the number of affiliates that originated the leads, determining by at least one processor of the computer system a respective affiliate quality score for the affiliate based at least in part on the determined lead quality scores of the leads generated by the respective affiliate, the affiliate quality score indicative of an assessment of quality of the leads generated by the respective affiliate.
